(19) United States
(12) Patent Application Publication
(10) Pub. No.: US 2006/0104367 A1
(43) Pub. Date: May 18, 2006

(54) Method and apparatus for improving audio-video signal sync stability in digital recording devices

(75) Inventors: Wilhelmus H.A Bruls, Eindhoven (NL); Reinier B.M Klein Gunnewiek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/541,056

(22) PCT Filed: Jan. 5, 2004
(86) PCT No.: PCT/IB04/00064

§ 371 Date: Jun. 29, 2005

Related U.S. Application Data
(60) Provisional application No. 60/438,219, filed on Jan. 6, 2003.

(51) Int. Cl. H04B 1/66; H04N 7/12; H04N 11/04; H04N 11/02

(52) U.S. Cl. 375/240.28; 375/240.26; 375/240.12; 375/240.2

(57) ABSTRACT

Video signals are converted into a stream of digital numbers arranged in a sequence of digitized video frames (14), neighboring frames being separated by a synchronization signal (16). A sensing circuitry (30) monitors the synchronization signals and detects absent synchronization signals. A clock generator (32) generates a replacement synchronization signal based on the monitored synchronization signals. The replacement signals can replace all of the synchronization signals, e.g., with an average sync frequency, or replace only missing or corrupted synchronization signals. The replacement synchronization signals are generated and inserted either at a fixed rate or at an actual clock rate. In a preferred embodiment, a learning circuitry (42) collects and averages the clock rate of the synchronization signals for a preselected duration. The value is supplied to the clock generator to output the replacement synchronization signals at the actual clock rate. A compression circuit (20) is clocked by the output of the clock generator.

The present invention relates to the art of digital recording. It finds particular application in conjunction with compressing the sequence of digital images, such as re-recording analog videotapes onto a digital medium and will be described with particular reference thereto. In a digital recording technology, the goal is to create a recording with very high similarity between the original signal and the reproduced signal. Those skilled in the art will appreciate applicability of the present invention to applications where a poor quality recording media introduces erroneous data into a chain of events, thus destroying the quality of the resulting image.

Typically, as an analog video camera takes a picture of a scene, it turns the picture into rows of individual dots called pixels. Each pixel is assigned a color and intensity. The rows of pixels are denoted by horizontal synchronization signals and frames are denoted by vertical synchronization signals, so that the electronics inside a TV set will know when to start new rows and frames of pixels. A digital video camera functions like an analog camera, but with an analog-to-digital converter mounted inside the enclosure. The analog-to-digital converter converts a received analog wave, which denotes a row of pixels, into a stream of digital numbers. Strings of digital numbers are arranged into a sequence of digitized frames, separated by the synchronization signals to define rows and frames.

The higher the analog-to-digital sampling rate, the better the digital image represents the analog image. The sampling is typically 13.5 MHz for video and 48 kHz for audio. A digitized video image requires a large amount of memory. A plurality of video images, such as a movie, requires hundreds of megabytes or even gigabytes of storage, if not compressed. Digital video recording system typically employs a compression circuit, or compressor for short, to compress and minimize the amount of data.

The U.S. digital television transmission standard for digital data compression is “MPEG” standard, conceived by Motion Pictures Expert Group. “MPEG” compression circuit employs a “lossy compression.” It is a non-reversible compression, in which the regenerated image is different from the original image. “MPEG” looks at similarities between successive frames of moving images and creates two groups of information: one contains all the important information and other gets all unimportant information. Only the important information needs to be kept and transmitted. The compression circuitry determines what has changed in each successive frame and records the changes to the image from the previous frame. The non-critical information is thrown away.

Another way of compression is “lossless compression” which employs Digital Component Technology, “DCT”, circuitry. It is a fully reversible compression, in which the regenerated image is exactly the same as the original image. The compression circuitry analyzes the successive frames to determine if any of two or more frames are the same. The reduction of the size of the digital data file is achieved by discarding the redundant information. This method finds a particular use when the video is destined to undergo further processing such as enlargement, rotation and/or chromakey. Some of unimportant details may suddenly become important and it may be necessary to spend more bits to accommodate what post production equipment can “see.” The “AMPEX DCT” videocassette format is an example of postproduction format using “lossless compression.”

However, end users have encountered problems associated with the compression circuits. For instance, when the source material is degraded, such as old VCR tapes with dropouts, the recording produces erroneous data (noise). The compression circuitry requires a reliable synchronization signal, which denotes an end of frame. When the synchronization signals are lost because of noise, the entire chain of the digital processing in the compression circuitry can become locked up for few seconds before the picture is restored. It results in the loss of frames and subsequent distortion of the image.

The present invention contemplates a new and improved method and apparatus that overcomes the above-reverenced problem and others.

In accordance with one aspect of the present invention, a digital signal processing apparatus is provided. A means converts the received video signals into a stream of digital numbers, arranged in a sequence of digitized frames. Neighboring frames are separated by a synchronization signal. A means monitors the synchronization signals. A means generates a replacement synchronization signal based on the monitored synchronization signals. A means compresses the digitized frames clocked by the replacement synchronization signals.

In accordance with another aspect of the present invention, a method of processing digital signal is provided. Video signals are converted into a sequence of digital values. The video signals and digital values sequence include synchronization signals that denote at least an interface between adjacent frames. The synchronization signals are monitored. A replacement synchronization signal is generated. The digitized frames are compressed in accordance with the generated, replacement synchronization signals.

One advantage of the present invention resides in providing a replacement synchronization signal when an original synchronization signal is absent due to the poor quality of the recording media; thus aiding in the prevention of lock ups of the compression circuitry.

Another advantage of the present invention resides in providing a self-adjusting, flexible replacement synchronization signal that is following the actual rate of the real-time synchronization signals.

Still further advantages and benefits of the present invention will become apparent to those of ordinary skill in the art upon reading and understanding the following detailed description of the preferred embodiments.

The invention may take form in various components and arrangements of components, and in various steps and arrangements of steps. The drawings are only for purposes of illustrating the preferred embodiments and are not be construed as limiting the invention.

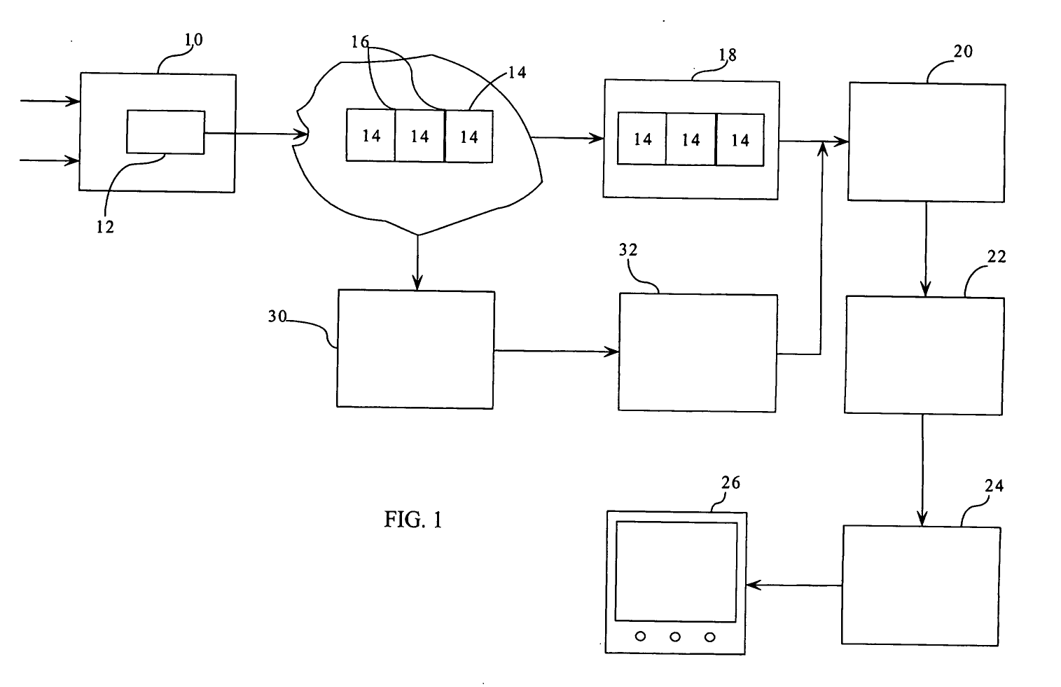

FIG. 1 is a diagrammatic illustration of an audio/video recording system in accordance with a present invention;

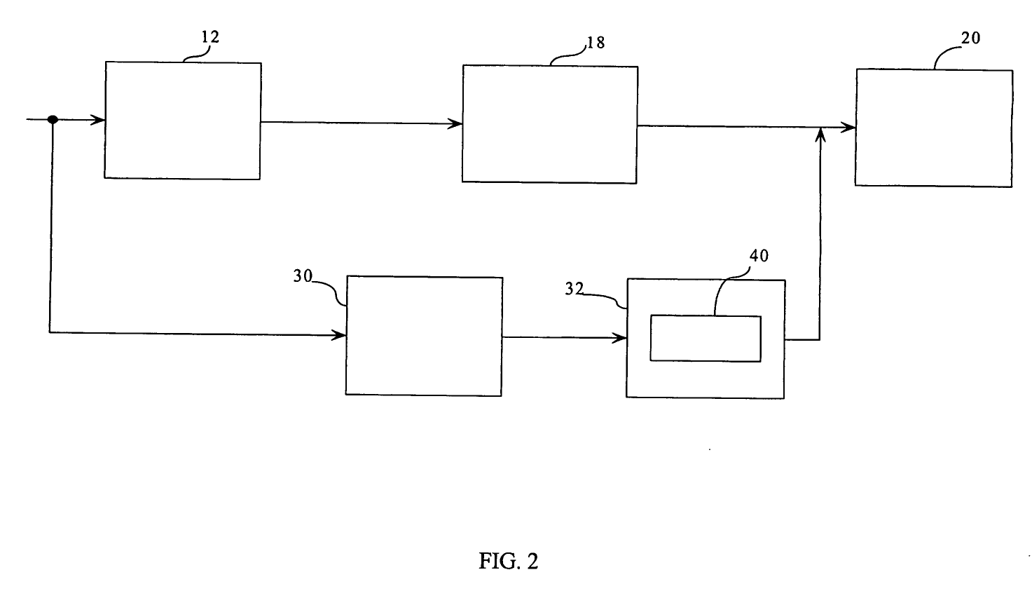

FIG. 2 is a diagrammatic illustration of several elements of FIG. 1, showing a fixed clock;

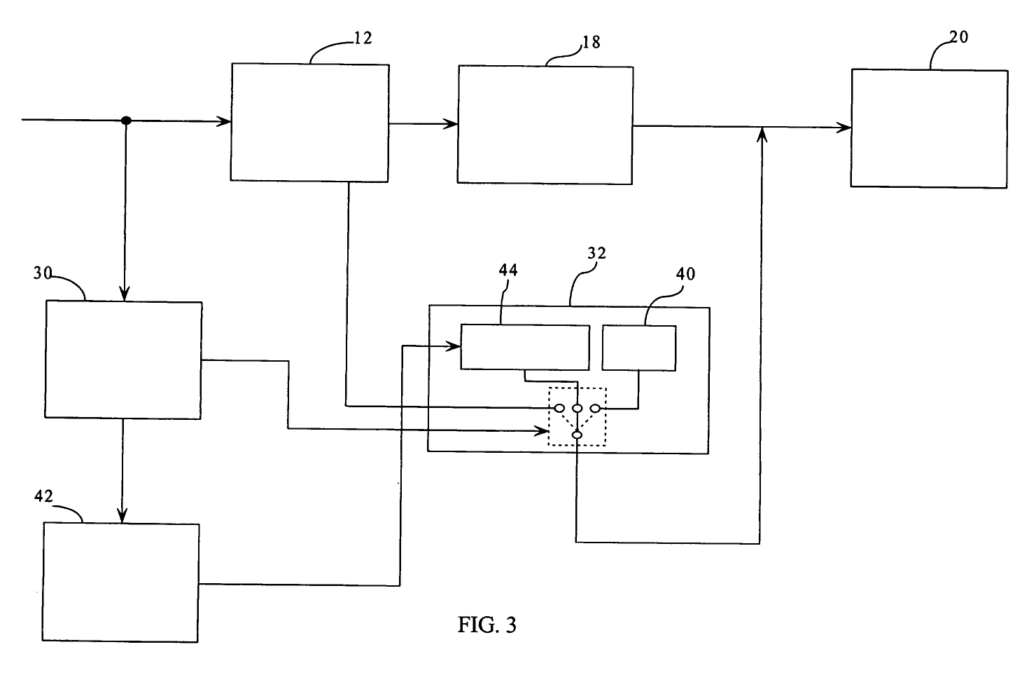

FIG. 3 is a diagrammatic illustration of several elements of FIG. 1, including a circuitry for a versatile clock;

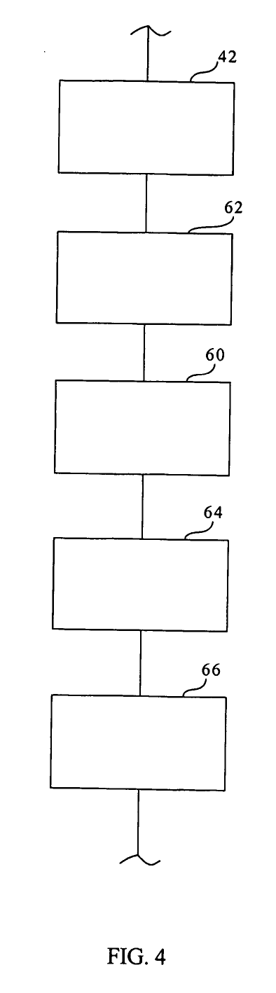

FIG. 4 is a flowchart of a method of generating a replacement synchronization signal at a variable speed.

With reference to FIG. 1, an audio/video digital image recording system typically includes a multi-media analog 10 with an analog-to-digital converter 12. The analog data is sampled by the analog-to-digital converter 12 and converted into a stream of digital numbers. The digital numbers are transmitted in a sequence of digitized frames 14. This transmission typically includes frame synchronization signals 16 that denote a frame return or simply separate one frame from the next. The digitized frames are transferred one by one into a frame storage or buffer 18 to allow a time delay for processing of the information. A block (frame) of video data enters the buffer 18 each time a sync pulse is passed from the analog-to-digital converter. Next, the digitized frames are transferred into compression circuitry 20. A block of video data is passed from the buffer to the compression circuitry 20 with each sync or clock pulse. The compression circuitry 20 looks at the successive digitized frames and compresses the digital data for storage, e.g. When a DVD player/recorder or other digital medium recorder 22 is played back, it is processed through a decoding circuitry 24 that converts the compressed data into a decompressed image. The decompressed image then might be displayed on a TV 26.

If at least one synchronization signal 16 is missing due to the noise, the frames are not separated and the compression circuitry receives too much data to analyze at a time. This causes lock ups of the compression circuitry and loss of frames. To resolve this problem, a sensing circuitry 30 monitors the data stream to determine if any synchronization signals are missing. For the 525 line, 60 Hz TV standard, the video camera takes pictures at a rate of 30 frames per second. Thus, the synchronization signal will be expected every 1/30 of a second. For a 625 line, 50 Hz TV standard, the video camera takes pictures at a rate of 25 frames per second. Thus, the synchronization signal will be expected every 1/25 of a second. A predetermined time window, based on the system specifications, is set up within the sensing circuitry 30 to look for the synchronization signals. If the synchronization signal is absent within the time window, the sensing circuitry 30 activates a clock generator 32, which provides replacement synchronization signals to clock the data from the buffer 18 to the compression circuitry 20. Each replacement synchronization signal is inserted into the sequence of digitized frames to provide a frame return for each frame or to separate frames from each other. The compression circuitry 20 receives the sequence of digitized frames with no missing synchronization signals and works properly.

In one embodiment, with reference to FIG. 2, video data is transmitted from the analog-to-digital converter 12 to the buffer 18, whenever the synchronization signal is passed from the analog-to-digital converter 12 to the buffer 18. The clock generator 32 has a fixed clock 40 producing synchronization pulses. The sensing circuitry 30 determines what standard is used (e.g., 50 or 60 Hz) and sets a correct fixed value of the system clock. At every synchronization pulse coming from fixed clock 40, the video data in the buffer 18 is passed to the compressor 20. No synchronization signal is missing and the compression circuitry 20 works properly. However, the real-time synchronization signals do not always come at the fixed rate. The video tape player or recorder may run slightly fast or slow. This can cause every now and then little motion irregularities after decoding the output stream of the compression circuitry 20.

With reference to FIG. 3, the audio/video recording system includes a learning circuitry 42. The clock generator 32 has a capacity to output signals at a variable speed by engaging a versatile clock 44. The speed of the versatile clock 44 is adjusted to match the frequency of the synchronization pulses of the incoming video signal. The clock generator can also pass stable synchronization pulses and only switch to the versatile or fixed clock when the sensing circuit senses missing pulses.

Further, with reference to FIG. 4, to initialize a learning process 60, a learning timer 62 is started. The learning circuitry 42 collects the information about frequencies of the synchronization signals detected by the sensing circuitry. More specifically, the learning process 60 measures the clock rate of the synchronization pulses. The learning circuitry averages 64 the synchronization rate information. The averaged synchronization pulse rate dynamically adjusts 66 the speed of the clock 44. Preferably, the averaging circuit 64 maintains a running average or median based on a fixed number of synchronization pulses, e.g. 50, so the clock rate changes with fluctuation in the synchronization pulse rate. When a missing synchronization pulse is detected, the versatile clock 44 starts supplying synchronization pulses at the average synchronization pulse rate and the learning timer 60 stops the averaging process 64 freezing the clock rate.

During the learning period, if the sensing circuitry 30 determines that a synchronization signal is missing, the clock generator 32 engages the fixed clock 40. The replacement synchronization signals are inserted at the fixed speed. When the learning process 60 has determined the synchronization pulse rate, the fixed clock 40 is disengaged and the versatile clock 44 is engaged.

After the conclusion of the initial learning process 60, the learning circuitry 42 continues computing the actual speed of the clock in a real-time domain. It records the frequency of each incoming synchronization signal and averages it in with previously computed values of the actual speed of the clock for each incoming synchronization signal. The new value is supplied to the clock generator to adjust the versatile clock 44 accordingly.

Alternatively, other techniques for analyzing the video data stream and forecasting when synchronization pulses should occur are contemplated. For example, clock rate fluctuation cycles can be used for more accurate clocking. As another option, the video data can be analyzed for clues. The frame synchronization time can be generated based on preceding horizontal return synchronization pulses. As yet another option, the video stream can be analyzed only for a fixed time as in the beginning of the learning process.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

Having thus described the preferred embodiments, the invention is now claimed to be:

1. A digital signal processing apparatus comprising:
a means (12) for converting a received video signal into a stream of digital numbers arranged in a sequence of digitized video frames, neighboring frames being separated by a synchronization signal;
a means (20) for compressing the digitized frames;
a means (30) for monitoring the synchronization signals; and
a means (32) for generating a synchronization signal in accordance with the monitored synchronization signals for clocking the digitized frames compressing means.

2. The apparatus as set forth in claim 1 wherein at least one synchronization signal is absent.

3. The apparatus as set forth in claim 2 wherein the monitoring means (30) detects an absence of the at least one synchronization signal.

4. The apparatus as set forth in claim 3 wherein the generating means (32) generates a replacement synchronization signal for the at least one absent synchronization signal.

5. The apparatus as set forth in claim 4 further including:
a means (18) for storing at least one digitized frame.

6. The apparatus as set forth in claim 4 wherein the means (12) for converting the received analog signal into the stream of digital numbers includes at least one analog-to-digital converter.

7. The apparatus as set forth in claim 4 wherein the means (32) for generating the replacement synchronization signal includes:
a fixed clock (40) for generating the replacement synchronization signals for the sequence of digitized frames at a fixed rate.

8. The apparatus as set forth in claim 7 further including:
a means (18) for buffering digitized frames during monitoring for the absence of synchronization signals, and generating of the replacement synchronization signal and inserting synchronization signals during the absence of incoming synchronization signals.

9. The apparatus as set forth in claim 4 further including:
a means (42) for determining a clock rate of the synchronization signals in one of the video signals and the sequence of digitized frames.

10. The apparatus as set forth in claim 9 wherein the means (32) for generating the replacement synchronization signal includes:
a means (44) for inserting the replacement synchronization signal into the sequence of digitized frames at the determined clock rate of the synchronization signals.

11. The apparatus as set forth in claim 10 further including:
a means (18) for storing at least two digitized frames to delay for the generation of replacement synchronization signals.

12. The apparatus as set forth in claim 4 further including:
a means (18) for storing a plurality of the digital frames; and,
a means (42) for averaging a clock rate of the synchronization pulses of the frames in the storing means and controlling the generating means to generate the replacement synchronization signals locked to the average clock rate.

13. The apparatus as set forth in claim 4 wherein the compressing means (20) is clocked by stable synchronization pulses when present and by pulses from the generating means in the absence of sensed synchronization pulses.

14. A method of processing digital signal comprising:
converting received video signals into a sequence of digital values, the video signals and the digital values sequence including synchronization signals that denote at least an interface between adjacent frames;
monitoring the synchronization signals of one of the video signals and the digital values sequence;
generating replacement synchronization signals; and
compressing the digitized frames in accordance with the generated replacement synchronization signals.

15. The method as set forth in claim 14 wherein the monitoring step includes:
monitoring for absent synchronization signals.

16. The method as set forth in claim 14 wherein the generating step includes:
generating a replacement synchronization signal at least for each absent synchronization signal.

17. The method as set forth in claim 16, further including:
inserting the replacement synchronization signals into the sequence of digitized frames at a fixed clock rate.

18. The method as set forth in claim 16, further including:
determining a frequency of the synchronization signals, the replacement synchronization signals being generated at the determined frequency.

19. The method as set forth in claim 18, further including:
in response to detecting absent synchronization signals before the clock rate of the synchronization signals is determined, generating the replacement synchronization signals at a preselected fixed clock rate.

20. The method as set forth in claim 14, further including:
monitoring a frequency of the synchronization signals; and
averaging the frequency over a plurality of the synchronization signals to determine an actual clock rate of the synchronization signals.

21. The method as set forth in claim 20, further including:
buffering a plurality of the digitized frames.

22. The method as set forth in claim 21, further including:
generating the replacement synchronization signals at the average frequency of the buffered digitized frames.

23. The method as set forth in claim 20 wherein the synchronization signal frequency is averaged for a preselected duration.

24. The method as set forth in claim 14 wherein the monitoring step includes:
monitoring for the synchronization signals in a time window based on a preselected nominal synchronization clock rate.

25. The method as set forth in claim 24 wherein the compressing step uses one of “MPEG” and “AMPEX DCT” compression.

26. The method as set forth in claim 14 further including:
clocking the compressing of the digitized frames with stable synchronization pulses;
monitoring for the absence of stable synchronization signals; and
in the absence of stable synchronization signals, inserting the replacement synchronization signals.

27. An audio/video digital imaging system comprising:
an analog-to-digital converter (12) which receives video signals and converts them into a sequence of digitized frames, adjacent pairs of frames being separated by a synchronization signal;
a sensing circuitry (30) which monitors for the synchronization signals;
a clock (32) which generates replacement synchronization signals in accordance with the monitored synchronization signals; and
a compression circuitry (20) which compresses the digitized frames at a clock rate set by the replacement synchronization signals.
